(19) United States
(12) Patent Application Publication
(10) Pub. No.: US 2026/0331690 A1
(43) Pub. Date: Oct. 22, 2026

(54) ALL-SOLID-STATE RECHARGEABLE BATTERY AND ALL-SOLID-STATE RECHARGEABLE BATTERY PACK INCLUDING THE SAME

(71) Applicant: SAMSUNG SDI CO., LTD., Yongin-si, Gyeonggi-do (KR)

(72) Inventors: Dongwoo KIM, Yongin-si, Gyeonggi-do (KR); Hyeoksoo HONG, Yongin-si, Gyeonggi-do (KR); Sang Il YI, Yongin-si, Gyeonggi-do (KR); Seok Joon YOON, Yongin-si, Gyeonggi-do (KR)

(21) Appl. No.: 18/880,441

(22) PCT Filed: Mar. 28, 2024
(86) PCT No.: PCT/KR2024/003900

§ 371 Date: Dec. 31, 2024

(30) Foreign Application Priority Data
Dec. 26, 2023 (KR) 10-2023-0191915

(51) Int. Cl. H01M 50/325; H01M 10/0562; H01M 10/0585; H01M 50/103; H01M 50/186

(52) U.S. Cl. CPC H01M 50/325; H01M 10/0562; H01M 10/0585; H01M 50/103; H01M 50/186

(57) ABSTRACT

[symbol]

an all-solid-state rechargeable battery according to an embodiment may include an all-solid-state cell including a positive electrode, a negative electrode, and a solid electrolyte layer, an all-solid-state case configured to contain the all-solid-state cell, a pair of fluid-containing members containing a fluid for pressurizing the all-solid-state cell, and in contact with an interior surface of the all-solid-state case, an inlet/outlet valve configured to introduce the fluid into an interior of the fluid-containing member and discharge, and a fluid supply unit connected to the inlet/outlet valve, and configured to supply the fluid to the fluid-containing member.

### TECHNICAL FIELD

The present disclosure relates to an all-solid-state rechargeable battery and an all-solid-state rechargeable battery pack including the same.

### BACKGROUND ART

Recently, as the explosion risk of batteries using liquid electrolytes has been reported, development of all-solid rechargeable batteries is being conducted. An all-solid rechargeable battery is a battery in which all materials are made of solid, and refers to a battery in which a solid electrolyte is used. The all-solid-state secondary battery has advantages in that the battery is safe because there is no risk of explosion due to electrolyte leakage, is easy to manufacture as a thin battery, has a high energy density, and is capable of implementing large capacity.

The above information disclosed in this background section is only for enhancement of understanding of the background of the disclosure, and therefore it may contain information that does not form the prior art that is already known in this country to a person of ordinary skill in the art.

### DISCLOSURE

### Technical Problem

The present disclosure attempts to provide an all-solid-state rechargeable battery and an all-solid-state rechargeable battery pack including the same, capable of stably maintaining the performance by applying constant pressure.

However, the technical problem to be solved by the present disclosure is not limited to the above, and other objects not mentioned herein will be understood from the following description by those skilled in the art.

### Technical Solution

In order to solve the technical object, an all-solid-state rechargeable battery according to an embodiment may include an all-solid-state cell including a positive electrode, a negative electrode, and a solid electrolyte layer, an all-solid-state case configured to contain the all-solid-state cell, a pair of fluid-containing members containing a fluid for pressurizing the all-solid-state cell, and in contact with an interior surface of the all-solid-state case, an inlet/outlet valve configured to introduce the fluid into an interior of the fluid-containing member and discharge, and a fluid supply unit connected to the inlet/outlet valve, and configured to supply the fluid to the fluid-containing member.

The all-solid-state case may include an upper case and a lower case separated from each other, and the fluid-containing member may include an upper fluid-containing member in contact with an interior upper surface of the upper case, and a lower fluid-containing member in contact with an interior lower surface of the lower case.

The fluid-containing member may include a flexible material.

An all-solid-state rechargeable battery may further include a plate located between the fluid-containing member and the all-solid-state cell, where the plate may include an upper plate located between the upper fluid-containing member and upper surface of the all-solid-state cell, and a lower plate located between the lower fluid-containing member and lower surface of the all-solid-state cell.

The inlet/outlet valve may include an inlet valve configured to introduce the fluid into the interior of the fluid-containing member, and an outlet valve configured to discharge the fluid from the interior of the fluid-containing member, and where the outlet valve is a relief valve that is opened when a pressure of the fluid becomes above a predetermined pressure.

The fluid supply unit may include a fluid storage tank configured to store the fluid, an inlet pipe configured to connect the fluid storage tank and the inlet valve, an outlet pipe configured to connect the fluid storage tank and the outlet valve, and a fluid supply pump installed in the fluid storage tank and providing a pressure for supplying the fluid.

An all-solid-state rechargeable battery may further include a temperature sensor installed in the fluid-containing member and configured to measure a temperature of the fluid.

The temperature sensor may be connected to the fluid supply pump, and configured to adjust a supply amount of the fluid according to the temperature of the fluid to constantly maintain the temperature of the fluid inside the fluid-containing member.

The inlet valve and the outlet valve may be installed on a side wall of the all-solid-state case.

The all-solid-state case may further include an insulation member located between the upper case and the lower case and configured to insulate the upper case and the lower case.

An all-solid-state rechargeable battery pack according to an embodiment may include a plurality of all-solid-state rechargeable battery modules that are stacked, where the all-solid-state rechargeable battery module may include a plurality of all-solid-state rechargeable batteries located on the same plane, and an engagement unit configured to engage adjacent all-solid-state rechargeable batteries with each other, where the all-solid-state rechargeable battery may include an all-solid-state cell including a positive electrode, a negative electrode, and a solid electrolyte layer, an all-solid-state case configured to contain the all-solid-state cell, a pair of fluid-containing members containing a fluid for pressurizing the all-solid-state cell, and disposed in contact with an interior surface of the all-solid-state case, an inlet/outlet valve configured to introduce the fluid into interior of the fluid-containing member and discharge, and a fluid supply unit connected to the inlet/outlet valve, and configured to supply the fluid to the fluid-containing member.

The inlet/outlet valve may include an inlet valve configured to introduce the fluid into the interior of the fluid-containing member, and an outlet valve configured to discharge the fluid from the interior of the fluid-containing member, and where the engagement unit is installed at the inlet valve and the outlet valve, and configured to engage the inlet valve and the outlet valve adjacent to the inlet valve with each other.

The all-solid-state case may include an upper case and a lower case that are separated from each other, and the fluid-containing member may include an upper fluid-containing member in contact with an interior upper surface of the upper case, and a lower fluid-containing member in contact with an interior lower surface of the lower case.

The all-solid-state rechargeable battery may further include a plate located between the fluid-containing member and the all-solid-state cell, and the plate may include an upper plate located between the upper fluid-containing member and upper surface of the all-solid-state cell, and a lower plate located between the lower fluid-containing member and lower surface of the all-solid-state cell.

The fluid supply unit may include a fluid storage tank configured to store the fluid, an inlet pipe configured to connect the fluid storage tank and the inlet valve, an outlet pipe configured to connect the fluid storage tank and the outlet valve, and a fluid supply pump installed in the fluid storage tank and providing a pressure for supplying the fluid.

The all-solid-state rechargeable battery may further include a temperature sensor installed in the fluid-containing member and configured to measure a temperature of the fluid.

### Advantageous Effects

According to an embodiment, by pressurizing an all-solid-state cell by a fluid pressure by using a pair of fluid-containing members and an inlet/outlet valve, the all-solid-state cell may be pressurized by a constant pressure regardless of a thickness change of the all-solid-state cell.

Therefore, the pressure applied to the all-solid-state cell may be maintained so the performance of the all-solid-state rechargeable battery may be stably maintained.

### DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a cross-sectional view of an all-solid-state battery.

FIG. 2 is a cross-sectional view of an all-solid-state battery including a precipitation-type negative electrode.

FIG. 3 is a schematic drawing of an all-solid-state rechargeable battery according to an embodiment.

FIG. 4 is a perspective view of the all-solid-state case, the inlet valve, and the fluid valve of FIG. 3.

FIG. 5 is a drawing schematically showing an all-solid-state cell of an all-solid-state rechargeable battery according to another embodiment.

FIG. 6 is a schematic drawing of an all-solid-state rechargeable battery pack including an all-solid-state rechargeable battery according to an embodiment.

FIG. 7 is an enlarged view of a portion A of FIG. 6.

FIG. 8 is an enlarged view of a portion B of FIG. 6.

### MODE FOR INVENTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly described to the contrary, the word “comprise” and variations such as “comprises” or “comprising” will be understood to imply the inclusion of stated elements but not the exclusion of any other elements.

In the drawings, the thicknesses of layers, films, panels, areas, regions, and the like are exaggerated for clarity, and like reference numerals designate like elements throughout the specification. It will be understood that when an element such as a layer, film, region, area or substrate is referred to as being “on” or “above” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here, “or” is not to be construed as an exclusive meaning, and for example, “A or B” is construed to include A, B, A+B, and the like.

### Positive Electrode for All-Solid Rechargeable Battery

An embodiment provides a positive electrode for an all-solid-state rechargeable battery including a current collector and a positive electrode active material layer located on the current collector, where the positive electrode active material layer includes at least one of a positive electrode active material, a sulfide-based solid electrolyte, a binder, and a conductive material. However, the present disclosure is not limited thereto, and the positive electrode for the all-solid-state rechargeable battery may include more or less components than the above-described components.

In an embodiment, the positive electrode for the all-solid-state rechargeable battery may be manufactured by applying the positive electrode composition including at least one of a positive electrode active material, a sulfide-based solid electrolyte, a binder, and a conductive material on the current collector, and then drying and rolling.

### Positive Electrode Active Material

The positive electrode active material may be applicable without limitation limit when it is generally-used to the all-solid-state rechargeable battery. For example, the positive electrode active material may be a compound allowing reversible intercalation and deintercalation of lithium, and may include a compound represented by one of the following formulas.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}CO_{b}X_{c}D_{α}(0.90≤a≤1.8, 0≤b≤0.5, 0≤c≤0.5, 0<α≤2);

LiₐNi_{1-b-c}CO_{b}X_{c}O_{2-α}T_{α}(0.90≤a≤1.8, 0≤b≤0.5, ≤0≤c 0.05, 0<α<2);

LiₐNi_{1-b-c}CO_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α}(0.90≤a≤1.8, 0≤b≤0.5, 0≤c≤0.05, 0<α≤2);

LiₐNi_{1-b-c}Mn_{b}X_{c}O_{2-α}T_{α}(0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS_{2;}

V₂O₅; LiV₂O_{5;}

LiZO_{2;}

LiNiVO_{4;}

Li_{(3-f)}J₂(PO₄)₃ (0≤f≤2);

Li_{(3-f)}Fe₂(PO₄)₃ (0≤f≤2);

LiₐFePO₄ (0.90≤a≤1.8).

In the above formulas, A is selected from the group consisting of Ni, Co, Mn, and a combination thereof, X is selected from the group consisting of Al, Ni, Co, Mn, Cr, Fe, Mg, Sr, V, rare earth element and a combination thereof, D is selected from the group consisting of O, F, S, P, and a combination thereof, E is selected from the group consisting of Co, Mn, and a combination thereof, T is selected from the group consisting of F, S, P, and a combination thereof, G is selected from the group consisting of Al, Cr, Mn, Fe, Mg, La, Ce, Sr, V, and a combination thereof, Q is selected from the group consisting of Ti, Mo, Mn, and a combination thereof, Z is selected from the group consisting of Cr, V, Fe, Sc, Y, and a combination thereof, and J is selected from the group consisting of V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate oxide (LFP), or the like.

The positive electrode active material may include a lithium nickel-based oxide represented by the following Chemical Formula 1, a lithium cobalt-based oxide represented by the following Chemical Formula 2, a lithium iron phosphate-based compound represented by the following Chemical Formula 3, or a combination thereof.

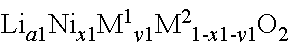

In the above Chemical Formula 2, it may be 0.9≤a1≤1.8, 0.3≤x1≤1, 0≤y1≤0.7, and M¹ and M² may be one or more elements selected from a group consisting of Al, B, Ba, Ca, Ce, Co, Cr, Cu, F, Fe, Mg, Mn, Mo, Nb, P, S, Si, Sr, Ti, V, W, and Zr, independently, and respectively.

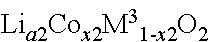

In the above Chemical Formula 2, it may be 0.9≤a2≤1.8, 0.6≤x2≤1, and M³ may be one or more elements selected from a group consisting of Al, B, Ba, Ca, Ce, Cr, Cu, F, Fe, Mg, Mn, Mo, Nb, P, S, Si, Sr, Ti, V, W, and Zr.

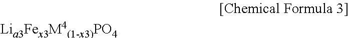

In the above Chemical Formula 3, it may be 0.9≤a3≤1.8, 0.6≤x3≤1, and M⁴ may be one or more elements selected from a group consisting of Al, B, Ba, Ca, Ce, Co, Cr, Cu, F, Fe, Mg, Mn, Mo, Nb, P, S, Si, Sr, Ti, V, W, and Zr.

An average particle diameter D50 of the positive electrode active material may be 1 μm to 25 μm, and for example, may be 3 μm to 25 μm, 5 μm to 25 μm, 5 μm to 20 μm, 8 μm to 20 μm, or 10 μm to 18 μm. The positive electrode active material having the particle diameter range may be harmoniously mixed with other components in the positive electrode active material layer, and may implement high-capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (X is an halogen element, e.g., I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers, respectively, and Z is Ge, Zn or Ga), Li₂S—GeS₂, Li₂S—SiS₂—Li₃PO₄, Li₂S—SiS₂-LiₚMO_{q} (p and q are integers, and M is P, Si, Ge, B, Al, Ga or In), or a combination thereof.

The sulfide-based solid electrolyte may be obtained by, for example, mixing Li₂S and P₂S₅ at a molar ratio of 50:50 to 90:10, or 50:50 to 80:20, and optionally heat treating the mixture. In the above mixing ratio range, the sulfide-based solid electrolyte having excellent ionic conductivity may be manufactured. Here, SiS₂, GeS₂, B₂S₃, or the like as other components may be further included to further improve the ionic conductivity.

A mechanical milling or solution method may be applied as a method of mixing sulfur-containing raw materials to prepare the sulfide-based solid electrolyte. The mechanical milling is a method of particulating and mixing starting materials by putting the starting materials, a ball mill, and the like in a reactor and stirring strongly the mixture. When using the solution method, the solid electrolyte may be obtained as a precipitate by mixing the starting materials in a solvent. In addition, when heat treatment is performed after mixing, crystals of the solid electrolyte may become more robust and the ionic conductivity may be improved. As an example, the sulfide-based solid electrolyte may be prepared by mixing sulfur-containing raw materials and heat-treating the sulfur-containing raw materials twice. In this case, the sulfide-based solid electrolyte having high ionic conductivity and robustness may be prepared.

As an example, the sulfide-based solid electrolyte particle may include argyrodite-type sulfide. The argyrodite-type sulfide may be represented by, for example, the Chemical Formula of LiₐM_{b}P_{c}S_{d}Aₑ (a, b, c, d and e all are 0 or more and 12 or less, M is a metal excluding Li or a combination of a plurality of metals excluding Li, and A is F, Cl, Br, or I), and for a specific example, may be represented by the Chemical Formula of Li₇₋ₓPS₆₋ₓAₓ (x is 0.2 or more and 1.8 or less, and A is F, Cl, Br, or I). The argyrodite-type sulfide may be specifically, Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide-based solid electrolyte particles containing such argyrodite-type sulfide may have high ionic conductivity close to the range of 10⁻⁴ to 10⁻² S/cm, which is ionic conductivity of a typical liquid electrolyte at room temperature, and may form a tight bond between the positive electrode active material and the solid electrolyte without causing the decrease in the ion conductivity, and further form a tight interface between the electrode layer and the solid electrolyte layer. The all-solid rechargeable battery containing this may improve the performance of the battery such as rate characteristics, coulombic efficiency, and lifespan characteristics.

The ajirodite type sulfide-based solid electrolyte may be prepared by, for example, mixing lithium sulfide, phosphorus sulfide, and optionally lithium halide. After mixing them, the heat treatment may be performed. The heat treatment may include, for example, two or more heat treatment steps.

The average particle size D50 of the sulfide-based solid electrolyte particles according to an embodiment may be 5.0 μm or less and may be, for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particles may be small particles having the average particle size D50 of 0.1 μm to 1.0 μm depending on the location or purpose of use, or may be large particles having an average particle size D50 of 1.5 μm to 5.0 μm. The sulfide-based solid electrolyte particles in this particle size range may effectively penetrate between the solid particles in the battery, and have excellent contactability with the electrode active material and the connectivity between the solid electrolyte particles. The average particle size of the sulfide-based solid electrolyte particles may be measured using a microscope image. For example, the particle size distribution may be obtained by measuring the size of about 20 particles in a scanning electron microscope image, and the D50 may be calculated from the particle size distribution.

The content of the solid electrolyte in the positive electrode for the all-solid rechargeable battery may be 0.5 wt % to 35 wt % and may be, for example, 1 wt % to 35 wt %, 5 wt % to 30 wt %, and 8 wt % to 25 wt %, or 10 wt % to 20 wt %. This is the content relative to the total weight of the components in the positive electrode, and specifically, may be the content relative to the total weight of the positive electrode active material layer.

In the embodiment, the positive electrode active material layer contains 50 wt % to 99.35 wt % of the positive electrode active material, 0.5 wt % to 35 wt % of sulfide-based solid electrolyte, and 0.1 wt % to 10 wt % of fluorinated resin binder, and 0.05 wt % to 5 wt % of vanadium oxide, based on 100 wt % of the positive electrode active material layer. When this content range is satisfied, the positive electrode for the all-solid rechargeable battery maintains the high adhesion while maintaining the high capacity and high ionic conductivity, and maintains the viscosity of the positive electrode composition at an appropriate level, thereby improving the processability.

### Binder

The binder serves to appropriately bind the positive electrode active material particles to each other and appropriately bind the positive electrode active material to the current collector. As a representative example of the binder, polyvinylalcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, or the like, may be used, but the binder is not limited thereto.

### Conductive Material

The positive electrode active material layer may further include a conductive material. The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt % with respect to a total weight of each component of the positive electrode for an all-solid-state battery, or with respect to the total weight of the first positive electrode active material layer. Within the above content range, the conductive material can improve electrical conductivity without deteriorating battery performance.

When the positive electrode active material layer further includes a conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of the vanadium oxide, and 0.1 wt % to 5 wt % of the conductive material with respect to 100 wt % of the positive electrode active material layer.

Meanwhile, the positive electrode for a lithium rechargeable battery may further include an oxide-based inorganic solid electrolyte, in addition to the solid electrolyte described above. The oxide-based inorganic solid electrolyte may include, for example, Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate(Li₃PO₄), lithium titanium phosphate(LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂(M=Te, Nb, or Zr; x is an integer of 1 to 10), or a combination thereof.

### All-Solid-State Rechargeable Battery

An embodiment provides an all-solid rechargeable battery including the positive electrode described above, the negative electrode, and a solid electrolyte layer positioned between the positive electrode and the negative electrode. The all-solid rechargeable battery may be referred to as an all-solid battery or an all-solid lithium rechargeable battery.

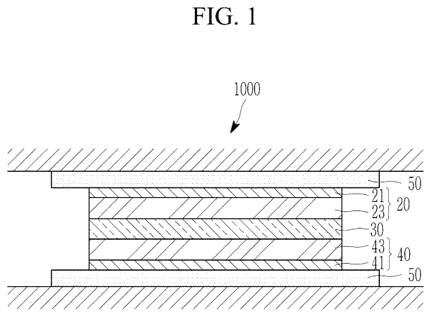

FIG. 1 is a cross-sectional view of the all-solid-state battery.

Referring to FIG. 1, an all-solid battery 1000 may have a structure in which an electrode assembly in which the negative electrode 40 including the negative electrode current collector 41 and the negative electrode active material layer 43, a solid electrolyte layer 30, and the positive electrode 20 including the positive electrode active material layer 23 and the positive electrode current collector 21 are stacked is accommodated in a case such as a pouch. The all-solid battery 1000 may further include the elastic layer 50 on an outer side of at least one of the positive electrode 20 and the negative electrode 40. Although FIG. 1 shows one electrode assembly including the negative electrode 40, the solid electrolyte layer 30, and the positive electrode 20, an all-solid battery may be manufactured by stacking two or more electrode assemblies.

### Negative Electrode

The negative electrode for an all-solid battery may include, for example, a current collector and the negative electrode active material layer disposed on the current collector. The negative electrode active material layer includes the negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped on lithium, or a transition metal oxide.

The material capable of reversibly intercalating/deintercalating lithium ions is a carbon-based the negative electrode active material, and may include, for example, crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used.

For the material capable of being doped or undoped on the lithium, a Si-based the negative electrode active material or an Sn-based the negative electrode active material may be used. Examples of the Si-based the negative electrode active material may include silicon, silicon-carbon composite, SiO_{X} (0<x<2), and a Si-Q alloy (Q is an element selected from the group consisting of alkali metals, alkali earth metals, Group 13 elements, Group 14 elements, Group elements, Group 16 elements, transition metals, rare-earth elements, and combinations thereof, but is not Si). Examples of the Sn-based the negative electrode active material may include Sn, SnO₂, a Sn—R alloy (R is an element selected from the group consisting of alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. Elements Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter D50 of the silicon particle may be 10 nm to 20 μm, and for example, 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter D50 is measured with a particle size analyzer using a laser diffraction method and refers to a diameter of a particle with a cumulative volume of 50% by volume in the particle size distribution.

The Si-based the negative electrode active material or Sn-based the negative electrode active material may be used by mixing with a carbon-based the negative electrode active material. A mixing ratio of the Si-based the negative electrode active material or Sn-based the negative electrode active material and the carbon-based the negative electrode active material may be 1:99 to 90:10 at a weight ratio.

The content of the negative electrode active material in the negative electrode active material layer may be 95 wt % to 99 wt % with respect to the total weight of the negative electrode active material layer.

In an embodiment, the negative electrode active material layer may further include a binder, and optionally, may further include a conductive material. A content of the binder in the negative electrode active material layer may be 1 wt % to 5 wt % with respect to the total weight of the negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, the water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When the water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state battery may be a precipitation-type negative electrode. The precipitation-type negative electrode refers to the negative electrode which does not include the negative electrode active material during assembling of a battery but in which lithium metal or the like is precipitated during charging of the battery and serves as the negative electrode active material.

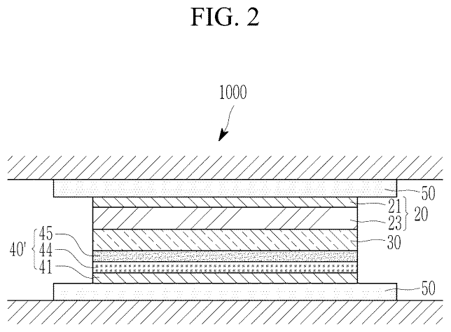

FIG. 2 illustrates a cross-sectional view of an all-solid battery including a precipitation-type negative electrode.

Referring to FIG. 2, a precipitation-type negative electrode 40′ may include a current collector 41 and the negative electrode coating layer 45 disposed on the current collector. In an all-solid battery having the precipitation-type negative electrode 40′, initial charging begins in the absence of the negative electrode active material, and during the charging, lithium metal with a high density or the like is precipitated between the current collector 41 and the negative electrode coating layer 45 and forms a lithium metal layer 44, which can serve as the negative electrode active material. Accordingly, in an all-solid battery that has been charged once or more, the precipitation-type negative electrode 40′ may include the current collector 41, the lithium metal layer 44 disposed on the current collector, and the negative electrode coating layer 45 disposed on the metal layer. The lithium metal layer 44 refers to a layer of lithium metal or the like precipitated during the charging process of the battery and may be called a metal layer or the negative electrode active material layer.

The negative electrode coating layer 45 may include metal, a carbon material, or a combination thereof that serves as a catalyst.

The metal may include, for example, gold, platinum, palladium, silicon, silver, aluminum, bismuth, tin, zinc, or a combination thereof, and may be composed of one selected therefrom or an alloy of more thone thereof. When the metal is present in the form of a particle, an average particle diameter D50 thereof may be about 4 μm or less, for example, 10 nm to 4 μm.

The carbon material may be, for example, crystalline carbon, amorphous carbon, or a combination thereof. The crystalline carbon may be, for example, natural graphite, artificial graphite, mesophase carbon microbead, or a combination thereof. The amorphous carbon may be, for example, carbon black, activated carbon, acetylene black, Denka black, Ketjen black, or a combination thereof.

When the negative electrode coating layer 45 includes both the metal and the carbon material, a mixing ratio of the metal and the carbon material may be, for example, 1:10 to 2:1 at a weight ratio. In this case, the precipitation of lithium metal can be effectively promoted and the characteristics of the all-solid-state battery can be improved. The negative electrode coating layer 45 may include, for example, a carbon material on which catalyst metal is supported, or a mixture of metal particles and carbon material particles.

The negative electrode coating layer 45 may include, for example, the metal and amorphous carbon, and in this case, the precipitation of lithium metal may be effectively promoted.

The negative electrode coating layer 45 may further include a binder, and the binder may be a conductive binder. Furthermore, the negative electrode coating layer 45 may further include general additives such as a filler, a dispersant, and an ion conductive material.

A thickness of the negative electrode coating layer 45 may be, for example, 100 nm to 20 μm, 500 nm to 10 μm, or 1 μm to 5 μm.

For example, the precipitation-type negative electrode 40′ may further include a thin film on the surface of the current collector, that is, between the current collector and the negative electrode coating layer. The thin film may contain an element that can form an alloy with lithium. The element that may form an alloy with lithium may be, for example, gold, silver, zinc, tin, indium, silicon, aluminum, bismuth, and the like, which may be used alone or as an alloy of more thone thereof. The thin film may further planarize a precipitation shape of the lithium metal layer 44 and further improve the characteristics of the all-solid battery. The thin film may be formed by, for example, a vacuum deposition method, a sputtering method, a plating method, or the like. A thickness of the thin film may be, for example, 1 nm to 500 nm.

### Solid Electrolyte Layer

The solid electrolyte layer 30 may include a sulfide-based solid electrolyte, an oxide-based solid electrolyte, and the like. The specific description of the sulfide-based solid electrolyte and the oxide-based solid electrolyte are the same as above.

In one example, the solid electrolyte included in the positive electrode 20 and the solid electrolyte included in the solid electrolyte layer 30 may include the same compound or different compounds. For example, when both the positive electrode 20 and the solid electrolyte layer 30 include an argyrodite-type sulfide-based solid electrolyte, the overall performance of the all-solid-state secondary battery can be improved. Furthermore, as an example, when both the positive electrode 20 and the solid electrolyte layer 30 include the coated solid electrolyte described above, the all-solid-state secondary battery can implement excellent initial efficiency and life characteristics while implementing high capacity and high energy density.

Meanwhile, the average particle diameter D50 of the solid electrolyte included in the positive electrode 20 may be smaller than the average particle diameter D50 of the solid electrolyte included in the solid electrolyte layer 30. In this case, the overall performance can be improved by maximizing the energy density of the all-solid-state battery and increasing the mobility of lithium ions. For example, the average particle diameter D50 of the solid electrolyte included in the positive electrode 20 may be 0.1 μm to 1.0 μm, or 0.1 μm to 0.8 μm, and the average particle diameter D50 of the solid electrolyte included in the solid electrolyte layer 30 may be 1.5 μm to 5.0 μm, 2.0 μm to 4.0 μm, or 2.5 μm to 3.5 μm. When the above particle diameter ranges are satisfied, the energy density of the all-solid rechargeable battery is maximized and the transfer of lithium ions is facilitated, making it possible to suppress resistance and thus to improve the overall performance of the all-solid rechargeable battery. Here, the average particle diameter D50 of the solid electrolyte may be measured with a particle size analyzer using a laser diffraction method. Alternatively, a particle size distribution may be obtained by measuring sizes of about 20 particles selected from a microscope image such as a scanning electron microscope, and a D50 value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate-based polymer, or a combination thereof may be used, but the present invention is not limited thereto, and any binder used in the art can be used. The acrylate-based polymer may be, for example, butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyryl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be 1 M or more, for example, 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂₀₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be imide-based, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a) one or more cations selected from ammonium, pyrrolidinium, pyridinium, pyrimidinium, imidazolium, piperidinium, pyrazolium, oxazolium, pyridazinium, phosphonium, sulfonium, triazolium and a mixture thereof, and b) one or more anions selected from BF₄—, PF₆—, AsF₆—, SbF₆—, AlCl₄—, HSO₄—, CIO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from the group consisting of N-methyl-N-propylpyrrolidinium bis(trifluoromethanesulfonyl)imide N-butyl-N-methylpyrrolidinium bis(3-trifluoromethylsulfonyl)imide, 1-butyl-3-methylimidazolium bis(trifluoromethylsulfonyl)amide and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer that satisfies the above ranges can maintain or improve ionic conductivity by improving the electrochemical contact area with the electrode. Accordingly, the energy density, discharge capacity, rate characteristics, and the like of the all-solid battery may be improved.

The all-solid battery may include a unit cell having a structure of the positive electrode/a solid electrolyte layer/a the negative electrode, a bi-cell structure having a structure of the positive electrode/a solid electrolyte layer/a the negative electrode/a solid electrolyte layer/a the positive electrode, or a stacked battery in which a structure of a unit battery is repeated.

A shape of the all-solid-state battery is not particularly limited, and may be, for example, a coin shape, a button shape, a sheet shape, a stack shape, a cylindrical shape, a flat shape, or the like. In addition, the all-solid battery may also be applied to large-sized batteries used in electric vehicles, and the like. For example, the all-solid battery may also be used in a hybrid vehicle such as a plug-in hybrid electric vehicle (PHEV). Furthermore, it may be used in fields that require a large amount of power storage, and for example, may also be used to an electric bicycle, an electric tool or the like.

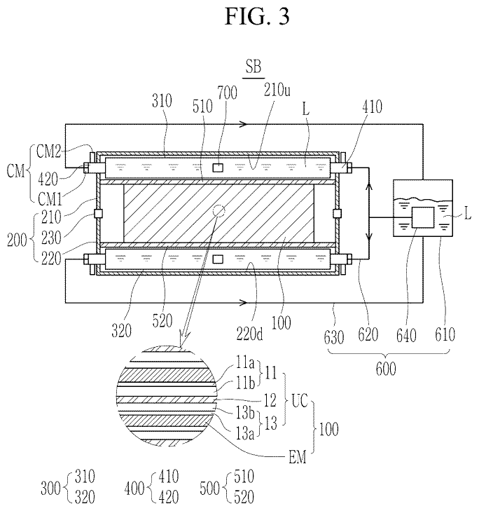

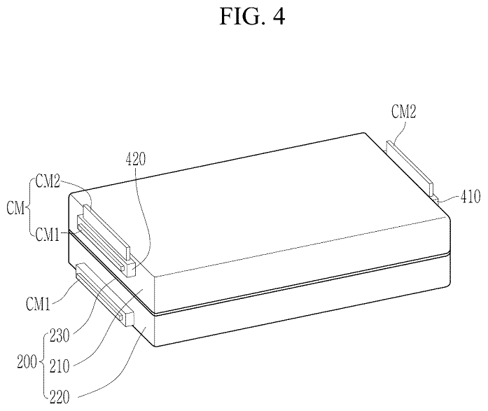

Hereinafter, the all-solid-state rechargeable battery according to an embodiment will be described in detail with reference to FIG. 3 and FIG. 4.

FIG. 3 is a schematic drawing of the all-solid-state rechargeable battery according to an embodiment, and FIG. 4 is a perspective view of the an all-solid-state case, the inlet valve, and the fluid valve of FIG. 3.

As shown in the FIG. 3, an all-solid-state rechargeable battery SB according to an embodiment may include an all-solid-state cell 100, an all-solid-state case 200, a pair of fluid-containing members 300, an inlet/outlet valve 400, a plate 500, a fluid supply unit 600, and a temperature sensor 700.

The all-solid-state cell 100 may have a stack cell structure in which a plurality of unit cells UC and a plurality of elastic members EM are stacked.

One unit cell UC may include the positive electrode 11, the negative electrode 13, and a solid electrolyte layer 12. Here, the positive electrode 11 may include the negative electrode, and the negative electrode 13 may include the positive electrode. The positive electrode 11 may include the positive electrode current collecting layer 11a and the positive electrode active material layer 11b disposed on one surface of the positive electrode current collecting layer 11a. The positive electrode current collecting layer 11a may include one of aluminum (Al), indium (In), copper (Cu), magnesium (Mg), stainless steel (SUS), titanium (Ti), iron (Fe), cobalt (Co), nickel (Ni), zinc (Zn), germanium (Ge), and lithium (Li). The positive electrode active material layer 11b may include one of lithium salts such as lithium nickel cobalt manganate (NCM), lithium cobalt oxide (LCO), lithium nickel oxide, lithium nickel cobalt oxide, lithium nickel cobalt aluminate (NCA), lithium manganate, or lithium iron phosphate, nickel sulfide, copper sulfide, lithium sulfide sulfur, iron oxide, or vanadium oxide.

The negative electrode 13 may include the negative electrode current collecting layer 13a and the negative electrode coating layer 13b disposed on one surface of the negative electrode current collecting layer 13a. The negative electrode current collecting layer 13a may have a plate or foil form. The negative electrode current collecting layer 13a may include various known metals and compounds that do not react to the lithium. The negative electrode current collecting layer 13a may include one of stainless steel (SUS), copper (Cu), titanium (Ti), iron (Fe), cobalt (Co), and nickel (Ni). The negative electrode coating layer 13b may include silver (Ag) and carbon (C), and is not limited thereto. For example, the negative electrode coating layer 13b may have a structure in which a carbon layer including at least one of carbon black (CB), furnace black (FB), acetylene black (AB), Ketjen black (KB), and graphene contains particles made of a metal or a semiconductor including at least one of gold (Au), platinum (Pt), palladium (Pd), silicon (Si), silver (Ag), aluminum (Al), bismuth (Bi), tin (Sn), and zinc (Zn). If charging the all-solid-state rechargeable battery, lithium (Li) may be precipitated between the negative electrode current collecting layer 13a and the negative electrode coating layer 13b so a lithium metal layer may be formed between the negative electrode current collecting layer 13a and the negative electrode coating layer 13b, the all-solid-state rechargeable battery may be discharged, the lithium precipitated between the negative electrode current collecting layer 13a and the negative electrode coating layer 13b may be removed so the negative electrode current collecting layer 13a may contact the negative electrode coating layer 13b.

The solid electrolyte layer 12 may be disposed between the positive electrode active material layer 11b and the negative electrode coating layer 13b. The solid electrolyte layer 12 may include various known sulfide-based solid electrolyte materials, and is not limited thereto. For example, the solid electrolyte layer 12 may include Li₂S—P₂S₅, Li₂S—P₂S₅—LiX (X is a halogen element, for example I, Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is one among Ge, Zn or Ga), Li₂S—GeS₂, Li₂S—SiS₂—Li₃PO₄, Li₂S—SiS₂-LipMOq (p and q are positive numbers, M is one among P, Si, Ge, B, Al, Ga, and In), or the like. The solid electrolyte layer 12 may include at least one of amorphous and crystalline matters.

The elastic member EM may include an elastic material such as rubber, an elastomer, or a foam. In order for lithium (Li) to grow and be reduced uniformly during charging and discharging of an all-solid-state secondary battery, uniform pressure must be applied to the entire area of the all-solid-state secondary battery. To this end, the elastic member EM may be installed between adjacent unit cells UC to provide the elastic force to the unit cell UC, thereby allowing a constant pressure to the unit cell UC.

However, the structure of the all-solid-state cell 100 is not limited thereto, and various structures are available.

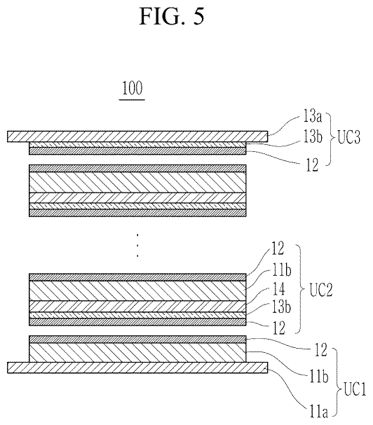

FIG. 5 is a drawing schematically showing the all-solid-state cell of the all-solid-state rechargeable battery according to another embodiment.

As shown in the FIG. 5, the all-solid-state cell 100 may have a stack cell structure in which a first unit cell UC1, a plurality of second unit cells UC2, and a third unit cell UC3 are stacked.

The first unit cell UC1 may include the negative electrode collector layer 11a, the positive electrode active material layer 11b, and the solid electrolyte layer 12 that are stacked, the second unit cell UC2 may include a bipolar plate 14, the positive electrode active material layer 11b and a negative electrode active material layer 13b formed on both surfaces of the bipolar plate 14, respectively, and a pair of solid electrolyte layers 12 formed on an outer surface of each of the positive electrode active material layer 11b and the negative electrode active material layer 13b, and the third unit cell UC3 may include the negative electrode collector layer 13a, the negative electrode active material layer 13b, and the solid electrolyte layer 12 that are stacked. Here, the bipolar plate 14 includes copper (Cu) and aluminum (Al), so that the positive and negative electrodes can exist simultaneously.

The first unit cell UC1, the second unit cell UC2, and the third unit cell UC3 may be electrically connected to each other through the solid electrolyte layer 12, and the plurality of second unit cells UC2 are stacked to be connected in series, thereby increasing a voltage of the all-solid-state cell 100.

Meanwhile, the all-solid-state cell 100 may be contained within the interior of the all-solid-state case 200. The all-solid-state case 200 may include an upper case 210, a lower case 220, and an insulation member 230.

The upper case 210 and the lower case 220 may be separated from each other and face each other. The upper case 210 and the lower case 220 may be formed of a conductive material. The insulation member 230 may be located between the upper case 210 and the lower case 220, and insulate the upper case 210 and the lower case 220. The insulation member 230 may be formed of a rubber ring, or the like.

As such, since the upper case 210 and the lower case 220 are separated based on the insulation member 230, the all-solid-state cell 100 therein may be exchanged after separating the upper case 210 and the lower case 220, making the maintaining and repair easy.

A fluid L for pressurizing the all-solid-state cell 100 may be contained in the pair of fluid-containing members 300, and the pair of fluid-containing members 300 may be in contact with an interior surface of the all-solid-state case 200.

The fluid-containing member 300 may include an upper fluid-containing member 310 in contact with an interior upper surface 210u of the upper case 210, and a lower fluid-containing member 320 in contact with an interior lower surface 220d of the lower case 220. The fluid-containing member 300 may include a flexible material. Therefore, the fluid-containing member 300≤can expand or contract.

The inlet/outlet valve 400 may introduce and discharge the fluid L into and from an interior of the fluid-containing member 300.

The inlet/outlet valve 400 may include an inlet valve 410≤configured to introduce the fluid L into the interior of the fluid-containing member 300, and an outlet valve 420≤configured to discharge the fluid L from the interior of the fluid-containing member 300.

The outlet valve 420 may be a relief valve that is opened when the pressure of the fluid L becomes above a predetermined pressure. Therefore, when the all-solid-state cell 100 expands, the pressure may be applied to the fluid-containing member 300 through the plate 500 in contact with the all-solid-state cell 100, and by this pressure, the outlet valve 420 may be opened so that the pressure applied to the fluid-containing member 300 may be minimized.

As such, by pressurizing the all-solid-state cell 100 by a fluid pressure using the pair of fluid-containing members 300 and the inlet/outlet valve 400, the all-solid-state cell 100 may be pressurized with a constant pressure regardless of the thickness change of the all-solid-state cell 100.

Therefore, the pressure applied to the all-solid-state cell 100 may be constantly maintained so the performance of the all-solid-state rechargeable battery SB may be stably maintained.

The inlet valve 410 and the outlet valve 420 may be installed on a side wall of the all-solid-state case 200.

The plate 500 may be located between the fluid-containing member 300 and the all-solid-state cell 100.

The plate 500 may include an upper plate 510 and a lower plate 520. The plate 500 may be formed of a conductive material.

The upper plate 510 may be located between the upper fluid-containing member 310 and an upper surface of the all-solid-state cell 100.

The lower plate 520 may be located between the lower fluid-containing member 320 and a lower surface of the all-solid-state cell 100.

The fluid supply unit 600 may be connected to the inlet/outlet valve 400, and may supply fluid to the fluid-containing member 300.

The fluid supply unit 600 may include a fluid storage tank 610, an inlet pipe 620, an outlet pipe 630, and a fluid supply pump 640.

The fluid storage tank 610 may store the fluid L. The fluid storage tank 610 may be an insulated tank thermally insulated from the outside.

The inlet pipe 620 may connect the fluid storage tank 610 and the inlet valve 410, and may provide a path for transporting the fluid L from the fluid storage tank 610 to the inlet valve 410.

The outlet pipe 630 may connect the fluid storage tank 610 and the outlet valve 420, and may provide a path for transporting the fluid L from the outlet valve 420 to the fluid storage tank 610. That is, the fluid L discharged by opening of the outlet valve 420 may be recollected to the fluid storage tank 610 through the outlet pipe 630.

The fluid supply pump 640 may be installed in the fluid storage tank 610, and may provide a pressure for supplying the fluid L. The fluid supply pump 640 may be a submersible pump that is installed underwater.

The temperature sensor 700 may be installed in the fluid-containing member 300, and may measure a temperature of the fluid L in real time. The temperature sensor 700 is connected to the fluid supply pump 640, and may adjust the supply amount of the fluid L according to the temperature of the fluid L. Therefore, the temperature of the fluid L inside the fluid-containing member 300 may be maintained constant.

Meanwhile, an all-solid-state rechargeable battery pack including the all-solid-state rechargeable battery according to an embodiment will be described in detail with reference to the drawings.

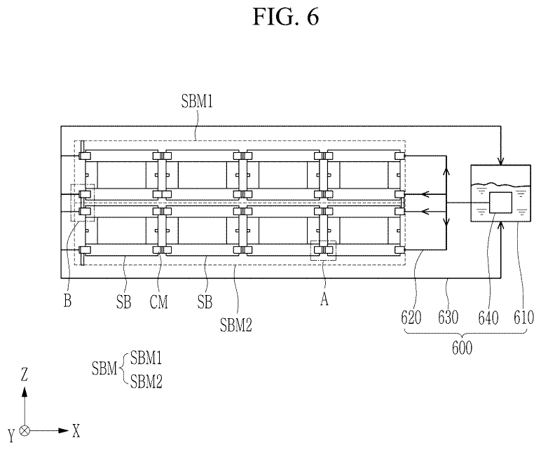

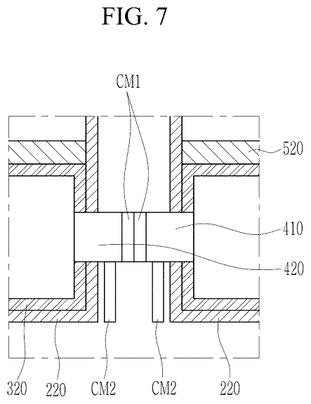

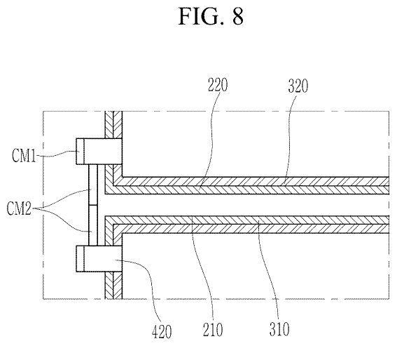

FIG. 6 is a schematic drawing of the all-solid-state rechargeable battery pack including the all-solid-state rechargeable battery according to an embodiment, and FIG. 7 is an enlarged view of a portion A of FIG. 6, and FIG. 8 is an enlarged view of a portion B of FIG. 6.

As shown in the FIG. 6 to FIG. 8, the all-solid-state rechargeable battery pack according to an embodiment may include a plurality of all-solid-state rechargeable battery modules SBM that are stacked. FIG. 6 illustrates a structure in which two all-solid-state rechargeable battery modules SBM1 and SBM2 are stacked in a third direction Z, which is a vertical direction, but without being limited thereto, depending on a required voltage capacity, various number of all-solid-state the rechargeable battery modules SBM may be stacked.

The all-solid-state the rechargeable battery module SBM may include a plurality of all-solid-state rechargeable batteries SB, and an engagement unit CM.

The plurality of all-solid-state rechargeable batteries SB may be located on the same plane among planes formed by a first direction X and a second direction Y, which are perpendicular to the third direction Z.

Although the embodiment of FIG. 6 illustrates a structure in which four all-solid-state rechargeable batteries SB are located on the same plane, is not limited thereto, various number of all-solid-state rechargeable batteries SB may be located depending on a required voltage capacity.

The engagement unit CM may engage adjacent all-solid-state rechargeable batteries SB with each other. The engagement unit CM may be installed at the inlet valve 410 and the outlet valve 420. The engagement unit CM may engage the inlet valve 410 and the outlet valve 420 adjacent thereto with each other. The engagement unit CM may include a first engagement unit CM1 configured to connect the all-solid-state rechargeable batteries SB located on the same plane with each other, and a second engagement unit CM2 configured to connect the all-solid-state rechargeable batteries SB located on another plane with each other. Here, the second engagement unit CM2 may engage the two all-solid-state rechargeable battery modules SBM1 and SBM2 that are adjacent in the third direction Z with each other.

The engagement unit CM may be implemented in various structures, such as screw-engagement and engagement through protrusions and depressions.

As such, by engaging the plurality of all-solid-state rechargeable batteries SB through the engagement unit CM installed at the inlet valve 410 and the outlet valve 420, the inlet valve 410 and the outlet valve 420 that are adjacent to each other may be interconnected, thereby interconnecting a plurality of fluid-containing member 300. Therefore, a path through which a fluid moves may be enlarged, and the capacity of the fluid-containing member 300 may be easily increased.

In addition, by engaging the plurality of all-solid-state rechargeable batteries SB through the engagement unit CM installed at the inlet valve 410 and the outlet valve 420, the number of the all-solid-state rechargeable battery SB may be increased or decreased without a separate connecting member such as a busbar, so that various voltage capacities of the all-solid-state rechargeable battery pack may be implemented.

In addition, since the plurality of all-solid-state rechargeable batteries SB may be engaged in various forms by using the engagement unit CM, the all-solid-state rechargeable battery pack may be manufactured in various forms.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

1. An all-solid-state rechargeable battery, comprising:
an all-solid-state cell comprising a positive electrode, a negative electrode, and a solid electrolyte layer;
an all-solid-state case configured to contain the all-solid-state cell;
a pair of fluid-containing members containing a fluid for pressurizing the all-solid-state cell, and in contact with an interior surface of the all-solid-state case;
an inlet/outlet valve configured to introduce the fluid into an interior of the fluid-containing member and discharge; and
a fluid supply unit connected to the inlet/outlet valve, and configured to supply the fluid to the fluid-containing member.

2. The all-solid-state rechargeable battery of claim 1, wherein
the all-solid-state case comprises an upper case and a lower case separated from each other, and
the fluid-containing member comprises:
an upper fluid-containing member in contact with an interior upper surface of the upper case; and
a lower fluid-containing member in contact with an interior lower surface of the lower case.

3. The all-solid-state rechargeable battery of claim 2, wherein the fluid-containing member comprises a flexible material.

4. The all-solid-state rechargeable battery of claim 2, further comprising a plate located between the fluid-containing member and the all-solid-state cell,
wherein the plate comprises:
an upper plate located between the upper fluid-containing member and upper surface of the all-solid-state cell; and
a lower plate located between the lower fluid-containing member and lower surface of the all-solid-state cell.

5. The all-solid-state rechargeable battery of claim 2, wherein the inlet/outlet valve comprises:
an inlet valve configured to introduce the fluid into the interior of the fluid-containing member; and
an outlet valve configured to discharge the fluid from the interior of the fluid-containing member, and
wherein the outlet valve is a relief valve that is opened when a pressure of the fluid becomes above a predetermined pressure.

6. The all-solid-state rechargeable battery of claim 5, wherein the fluid supply unit comprises:
a fluid storage tank configured to store the fluid;
an inlet pipe configured to connect the fluid storage tank and the inlet valve;
an outlet pipe configured to connect the fluid storage tank and the outlet valve; and
a fluid supply pump installed in the fluid storage tank and providing a pressure for supplying the fluid.

7. The all-solid-state rechargeable battery of claim 6, further comprising a temperature sensor installed in the fluid-containing member and configured to measure a temperature of the fluid.

8. The all-solid-state rechargeable battery of claim 7, wherein the temperature sensor is connected to the fluid supply pump, and configured to adjust a supply amount of the fluid according to the temperature of the fluid to constantly maintain the temperature of the fluid inside the fluid-containing member.

9. The all-solid-state rechargeable battery of claim 2, wherein the inlet valve and the outlet valve are installed on a side wall of the all-solid-state case.

10. The all-solid-state rechargeable battery of claim 2, wherein the all-solid-state case further comprises an insulation member located between the upper case and the lower case and configured to insulate the upper case and the lower case.

11. An all-solid-state rechargeable battery pack, comprising a plurality of all-solid-state rechargeable battery modules that are stacked,
wherein the all-solid-state rechargeable battery module comprises:
a plurality of all-solid-state rechargeable batteries located on the same plane; and
an engagement unit configured to engage adjacent all-solid-state rechargeable batteries with each other,
wherein the all-solid-state rechargeable battery comprises:
an all-solid-state cell comprising a positive electrode, a negative electrode, and a solid electrolyte layer;
an all-solid-state case configured to contain the all-solid-state cell;
a pair of fluid-containing members containing a fluid for pressurizing the all-solid-state cell, and disposed in contact with an interior surface of the all-solid-state case;
an inlet/outlet valve configured to introduce the fluid into interior of the fluid-containing member and discharge; and
a fluid supply unit connected to the inlet/outlet valve, and configured to supply the fluid to the fluid-containing member.

12. The all-solid-state rechargeable battery pack of claim 11, wherein the inlet/outlet valve comprises:
an inlet valve configured to introduce the fluid into the interior of the fluid-containing member; and
an outlet valve configured to discharge the fluid from the interior of the fluid-containing member, and
wherein the engagement unit is installed at the inlet valve and the outlet valve, and configured to engage the inlet valve and the outlet valve adjacent to the inlet valve with each other.

13. The all-solid-state rechargeable battery pack of claim 12, wherein,
the all-solid-state case comprises an upper case and a lower case that are separated from each other, and
the fluid-containing member comprises:
an upper fluid-containing member in contact with an interior upper surface of the upper case; and
a lower fluid-containing member in contact with an interior lower surface of the lower case.

14. The all-solid-state rechargeable battery pack of claim 13, wherein
the all-solid-state rechargeable battery further comprises a plate located between the fluid-containing member and the all-solid-state cell, and
the plate comprises:
an upper plate located between the upper fluid-containing member and upper surface of the all-solid-state cell; and
a lower plate located between the lower fluid-containing member and lower surface of the all-solid-state cell.

15. The all-solid-state rechargeable battery pack of claim 14, wherein the fluid supply unit comprises:
a fluid storage tank configured to store the fluid;
an inlet pipe configured to connect the fluid storage tank and the inlet valve;
an outlet pipe configured to connect the fluid storage tank and the outlet valve; and
a fluid supply pump installed in the fluid storage tank and providing a pressure for supplying the fluid.

16. The all-solid-state rechargeable battery pack of claim 15, wherein the all-solid-state rechargeable battery further comprises a temperature sensor installed in the fluid-containing member and configured to measure a temperature of the fluid.
